(19) United States
(12) Patent Application Publication
(10) Pub. No.: US 2007/0006113 A1
(43) Pub. Date: Jan. 4, 2007

(54) Determining an optimizaton for generating a pixelated photolithography mask with high resolution imaging capability

(76) Inventors: Bin Hu, Portland, OR (US); Vivek Singh, Portland, OR (US); Bikram Baidya, Hillsboro, OR (US); Kenny Toh, Portland, OR (US); Srinivas Bollepalli, Aloha, OR (US); Yan Borodovsky, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,394

(22) Filed: Jun. 30, 2005

(51) Int. Cl. G06F 17/50

(52) U.S. Cl. 716/19; 716/21

(57) ABSTRACT

A pixelated photolithography mask is optimized for high resolution microelectronic processing. In one embodiment, the invention includes synthesizing a pixelated photolithography mask, applying a pixel flipping function to the mask, comparing the resulting mask to a desired result, and synthesizing an optimized pixelated binary photolithography mask using the function.

### FIELD

The present description relates to semiconductor photolithography and, in particular, to optimizing a pixelated photolithography mask by modifying pixels for diffractive effects.

### BACKGROUND

In the production of semiconductors, such as memory, processors, and controllers, among others, a mask is used. The mask is placed over a semiconductor wafer to expose or shield different portions of the wafer from light, or some other element. The exposed wafer is then processed with etching, deposition and other processes to produce the features of the various semiconductors in the wafer that make up the finished product.

The masks are designed using computer design programs that derive an aerial view or image of the wafer based on the electronic circuitry that is to be built on the wafer. The mask is designed to produce this aerial image on the wafer in the particular photolithography equipment that is to be used. In other words the mask must be designed so that when a particular wavelength of light at a particular distance is directed to a wafer through a particular set of optics and the mask, the desired pattern will be illuminated with the desired intensity on the wafer.

The pattern on the mask may be very complex and finely detailed. In some systems, a mask is designed with a matrix of pixels in columns and rows that illuminate a wafer that has an area of about one square centimeter. The mask may be four or more times that size and reduction optics are used to reduce the mask image down to the size of the wafer. For a 193 nm light source, each pixel may be about 100 nm across so that the mask may have billions of pixels. Each pixel is either a transparent spot on the mask (1), an opaque spot on the mask (0), or a transparent spot that reverses the phase of the light passing through (−1). The use of three different values (+1, 0, −1) allows for greater control over the diffractive effects through the mask.

In order to enhance the accuracy and the resolution of the pattern that results on the wafer. A variety of different optimization techniques are typically applied to the mask. The techniques go by different names, including OPC (Optical Proximity Correction), and normally move edges of the patterns on the mask to compensate for variations in the manufacturing process and to allow for diffractive effects. The manufacturing process variations are normally compensated for by applying design rule restrictions. Design rules define pattern dimensions and shapes that cannot reliably be reproduced by the manufacturing process, for example, lines that are too thin, features that are too isolated etc. The restrictions are applied to change the pattern on the mask based on the rules. The design rule restrictions make it impossible to produce some circuits on the wafer. The circuit must then be redesigned, adding cost and probably reducing the final product's performance.

Another way to enhance the accuracy is to make two exposures. The first mask establishes a basic pattern and the second mask enhances the pattern to compensate for design rules that are violated by the first mask. Using two masks greatly increases the time and cost of producing each layer and therefore the cost of the eventual resulting product. Often, these and more techniques are used together to establish a final mask design.

### BRIEF DESCRIPTION OF THE DRAWINGS

Embodiments of the present invention may be understood more fully from the detailed description given below and from the accompanying drawings of various embodiments of the invention. The drawings, however, should not be taken to be limiting, but are for explanation and understanding only.

FIG. 1 is a diagram of a semiconductor fabrication device suitable for application to the present invention;

FIG. 2 is a process flow diagram of modifying a mask according to an embodiment of the present invention;

FIG. 3 is a process flow diagram of modifying a mask according to another embodiment of the present invention; and

FIG. 4 is an example of a computer system capable of performing aspects of the present invention.

### DETAILED DESCRIPTION OF THE INVENTION

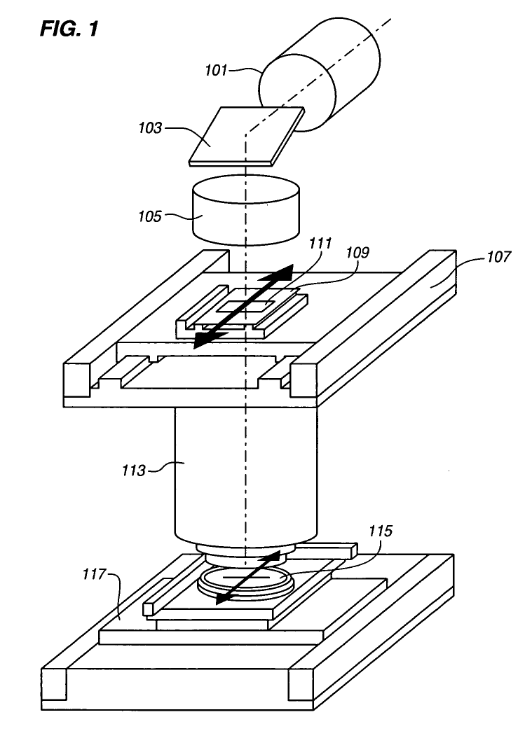

FIG. 1 shows a conventional semiconductor fabrication machine, in this case, a lens-scanning ArF Excimer Laser Stepper. The stepper may be enclosed in a sealed vacuum chamber (not shown) in which the pressure, temperature and environment may be precisely controlled. The stepper has an illumination system including a light source 101, such as an ArF excimer laser, a scanning mirror 103, and a lens system 105 to focus the laser light on the wafer. A reticle scanning stage 107 carries a reticle 109 which holds the mask 111. The light from the laser is transmitted onto the mask and the light transmitted through the mask is focused further by a projection lens with, for example, a four fold reduction of the mask pattern onto the wafer 115.

The wafer is mounted to a wafer scanning stage 117. The reticle scanning stage and the wafer scanning stage are synchronized to move the reticle and the wafer together across the field of view of the laser. In one example, the reticle and wafer move across the laser light in a thin line, then the laser steps down and the reticle and wafer move across the laser in another thin line until the entire surface of the reticle and wafer have been exposed to the laser. Such a step and repeat scanning system allows a high intensity narrow beam light source to illuminate the entire surface of the wafer. The stepper is controlled by a station controller (not shown) which may control the starting, stopping and speed of the stepper as well as the temperature, pressure and chemical makeup of the ambient environment, among other factors. The stepper of FIG. 1 is an example of a fabrication device that may benefit from embodiments of the present invention. Embodiments of the invention may also be applied to many other photolithography systems.

The mask controls the size of each feature on the wafer. The mask design is made up of chrome metal lines or lines of some other material of different widths and shapes designed to create a particular pattern on the wafer. When OPC (Optical Proximity Correction) is applied to the mask, the mask is modified iteratively, primarily by modifying the widths of the metal lines and adding decorations to corners, until the photolithography model predicts that the final wafer will match the intended target design.

In one embodiment, the present invention includes a method for designing a full-field mask using sub-wavelength diffractive optical elements such as pixels with discrete transmission states, such as (1, 0, −1). The method enables single exposure patterning with no design-rule restrictions. In one example, the present invention may be described as an integrated system made up of several components. These components may include the following components although additional components may be added and not all components are necessary:

A method to determine an initial pixelated mask that is close to the optimal point;

A convolution based objective function to evaluate the merit of a given pixel mask;

A variety of different schemes to determine how to flip a group of pixels to achieve fast convergence for synthesizing the entire mask;

A method to perform constrained pixel optimization, to take into account the mask manufacturing limitations; a pixel traversal order, to determine the sequence of pixels to be optimized;

A method for synthesizing the pixel mask for optimal through-focus behavior;

A mask model, to accurately compute the diffracted fields from the pixelated mask; and

An imaging model.

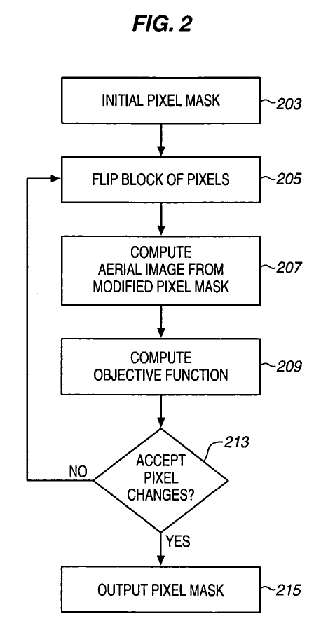

FIG. 2 shows a generalized process flow of a mask optimization process according to one embodiment of the invention. In FIG. 2, the process begins with an initial pixel mask at block 203, such as a binary pixelated photolithography mask of the type mentioned above.

The pixelated mask may be constructed from a quartz plate with transparent or opaque chrome pixels. The pixels may be in rows and columns. Each pixel is an area on the quartz plate which is roughly square. The pixels may be either transparent (+1, −1), so light passes through or opaque (0) so that the light is blocked. The transparent areas may either reverse the phase of the light as it passes through (−1) or leave the phase of the light unaffected (+1). The pixelated mask can therefore be represented as a matrix of rows and columns with each position in the matrix having a value of +1, 0, or −1.

This matrix is convolved with the kernel function to determine the electric field at all of the positions on the wafer that are caused by exposure to light through the mask. The kernel functions are derived based on the photolithography equipment with which the mask will be used. The kernel function may take into consideration the nature of the light source, any lenses or filters between the light source and the mask, the type of mask that is to be used, the geometry of the chamber and physical characteristics of the wafer that will be processed, as well as many other factors. The electric field is of interest because the electric field strength squared gives the intensity. The intensity is directly related to the effect on the photoresist that is being exposed through the mask. If the intensity exceeds a certain threshold value then the resist will be exposed sufficiently to be etched away in the next process.

At block 205, blocks of pixels are flipped according to some function. Flipping a pixel means changing its value from one state to another state. There are three states in typical pixel optimization, i.e., 1, 0, and −1. There are a variety of different functions that may be applied to such an operation. Some possibilities include:

different size block pixel flip with a fixed maximum,

different size block pixel flip with a variable iterated maximum,

random set of pixels flipped as group,

objective weighted blocks, context weighted line block with maximum limit decreasing with iteration,

context weighted rectangular block with maximum limit decreasing with iteration,

iterated initial conditions,

single or block pixel flip with the center pixel selected randomly at every iteration;

single or block pixel flip with the center pixel selected in a spiral patch starting from the center of the chip;

single or block pixel flip with the selection order for the center pixel dependent on its contribution to change in an objective function by the pixel in the previous iteration;

single or block pixel flip as above on a few selected masks that are selected based on the objective function from a population of masks created using the Genetic Algorithm based principles of mutation and crossover of the masks from the previous iteration; and

pixel flipping on a population of masks created by randomly flipping partitions of masks from the previous iteration, where partitions are formed by structures in the masks along with their neighborhood;

among others.

Some of the pixel flipping functions above vary in their traversal orders, which determine the sequence of pixels to be optimized. In sequential traversal, the pixel to be flipped is selected in a deterministic order, normally either x-wise or y-wise. This scheme may give faster convergence for mask synthesis. In random traversal, the pixel to be flipped is determined randomly. This scheme gives a more global solution, that is an approach that is more likely to be successful when applied to the entire mask.

At block 207, an aerial image is computed from the mask that was determined in the block flipping operation. This may be done by convolving the pixel flipped matrix with a kernel function to determine the electric field at all of the positions on the wafer that are caused by exposure to light through the mask. The kernel functions are derived based on the photolithography equipment with which the mask will be used. The kernel function may take into consideration the nature of the light source, any lenses or filters between the light source and the mask, the type of mask that is to be used, the geometry of the chamber and physical characteristics of the wafer that will be processed, as well as many other factors. The electric field is of interest because the electric field strength squared gives the intensity. The intensity is directly related to the effect on a photoresist layer on a wafer that is being exposed through the mask. If the intensity exceeds a certain threshold value then the resist will be exposed sufficiently to be etched away in the next manufacturing process.

The aerial image is then compared to a target image to evaluate the merit of the pixel flipping operation at block 209. At block 211, the pixel changes are either accepted or rejected based on the evaluation. The process then returns to block 205 to flip another block or, when the process is completed, then the output pixel mask is produced at block 213. The output pixel mask may be used to produce microelectronic devices in photolithography.

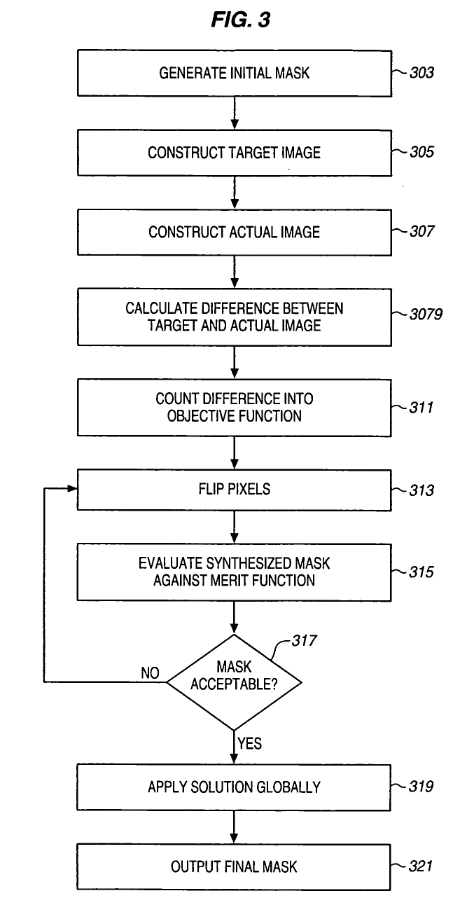

FIG. 3 shows a more detailed process of mask optimization according to an embodiment of the present invention. In FIG. 3, an initial pixelated layout for the mask may be generated at block 303 through, for example, pixelation of a phase-colored drawn layout. For faster convergence toward the target pattern and therefore faster mask synthesis, the initial pixelation is as close to the target pattern as possible. In one example, an initial pixelation may be generated by first phase coloring the drawn mask layout using a phase coloring operation, which assigns different phases for neighboring polygons. Then, the states of phase conflicted polygons are flipped and resultant images and merit functions are calculated. Finally, the coloring scheme corresponding to the minimum merit function value is selected as the initial condition.

Given the initial mask, a convolution based objective function may be constructed to evaluate the merit of a modified pixel mask. First, a target image is constructed, at block 305, by for example, convolving the drawn layout with a square window function. Second, at block 307, an actual image is computed from the modified pixel mask. Then at block 309, the difference between the target image and the actual image is calculated. This is applied to an objective function at block 311, based on the evaluation location. The objective function is calculated by summing up all the differences from block 309. In this operation, different treatments may be needed for opaque regions than for clear regions.

At block 313 operations are applied to flip pixels either one at a time or in blocks. Any one or more of the operations listed above may be applied to flip the pixels. If the states of a group of pixels are flipped, this may be denoted as block-flip. In one embodiment, a small portion of the mask is synthesized and the pixel flipping is applied only to some of the pixels of that group. The particular pixels to be flipped are selected based on the pixel flipping function. If the pixel flipping function works well, then it may be applied to the rest of the mask. By working on just a small portion of the mask, the determination of the best function or combination of functions is made easier. Functions are selected with an aim to achieve fast convergence of the mask synthesis with the target image using an approach that may be applied to the entire mask.

The selection of pixel flipping functions may be tailored to account for a variety of different mask manufacturing constraints. Constrained pixel optimization may be achieved through the use of the block-flip schemes mentioned above.

At block 315, the synthesized mask after one or more pixels are flipped is evaluated against a merit function. This may be done in a manner similar to that described above with respect to blocks 207, 209, and 211. Conventional merit functions may be used or the function may be weighted. In one embodiment, through-focus behavior may be accounted for. Through-focus behavior refers to the limited accuracy of the focusing system in the optical illumination system used in producing wafers. Because the automatic focusing system can not ensure that the illumination system will be perfectly focused on the wafer during production, the image of the mask on the wafer may be blurred. A through-focus merit function may be calculated for a synthesized mask as a weighted summation of individual merit functions at several different possible focus points. The weights may then be distributed through focus uniformly, in a Gaussian distribution, or in other ways depending on the production equipment and the accuracy required.

Another effect which may be compensated for in the merit function evaluation is thick mask effects. When the mask is very thick compared to the wavelength of the illumination, then the light may be diffracted as it passes through the mask. In one example, a mask coating may be approximately 100 nm thick, while the illumination may have a wavelength of approximately 200 nm. One approach to compensating for a thick mask is described in U.S. patent application Ser. No. 10/789,703, filed Feb. 27, 2004, entitled Quick and Accurate Modeling of Transmitted Fields.

In one embodiment, the merit function is calculated based on a synthesized mask that takes all of these effects into consideration. Other effects may also be accommodated. The mask may be synthesized in any of a variety of different ways for comparison with the target image. One approach is to calculate only the changes from the last synthesized mask. Such an approach is described in U.S. patent application Ser. No. 11/096,613, filed Mar. 31, 2005, entitled Modification of Pixelated Photolithography Masks Based on Electric Fields.

Based on the application of the merit function, the synthesized mask is either accepted at block 317 or rejected and a different pixel flipping function is applied at block 313. If the synthesized mask is accepted, then at block 319, the pixel flipping process is applied globally to the entire mask and then at block 321, a complete optimized output mask is generated.

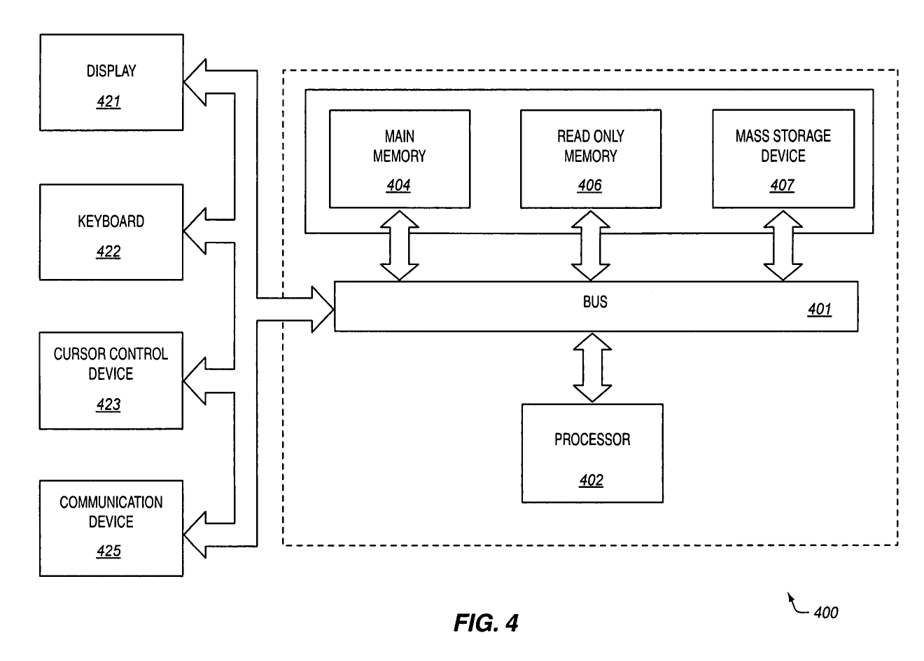

A computer system 400 representing an example of a system upon which features of the present invention may be implemented is shown in FIG. 4. The computer system 400 includes a bus or other communication means 401 for communicating information, and a processing means such as a microprocessor 402 coupled with the bus 401 for processing information. The computer system 400 further includes a main memory 404, such as a random access memory (RAM) or other dynamic data storage device, coupled to the bus 401 for storing information and instructions to be executed by the processor 402. The main memory also may be used for storing temporary variables or other intermediate information during execution of instructions by the processor.

The computer system may also include a nonvolatile memory 406, such as a read only memory (ROM) or other static data storage device coupled to the bus for storing static information and instructions for the processor. A mass memory 407 such as a magnetic disk or optical disc and its corresponding drive may also be coupled to the bus of the computer system for storing information and instructions.

The computer system can also be coupled via the bus to a display device or monitor 421, such as a cathode ray tube (CRT) or Liquid Crystal Display (LCD), for displaying information to a user. For example, graphical and textual indications of installation status, operations status and other information may be presented to the user on the display device. Typically, an alphanumeric input device 422, such as a keyboard with alphanumeric, function and other keys, may be coupled to the bus for communicating information and command selections to the processor. A cursor control input device 423, such as a mouse, a trackball, or cursor direction keys can be coupled to the bus for communicating direction information and command selections to the processor and to control cursor movement on the display 421.

A communication device 425 is also coupled to the bus 401. The communication device 425 may include a modem, a network interface card, or other well known interface devices, such as those used for coupling to Ethernet, token ring, or other types of physical attachment for purposes of providing a communication link to support a local or wide area network (LAN or WAN), for example. In this manner, the computer system may also be coupled to a number of clients or servers via a conventional network infrastructure, including an intranet or the Internet, for example.

It is to be appreciated that a lesser or more equipped computer system than the example described above may be preferred for certain implementations. Therefore, the configuration of the exemplary computer system 400 will vary from implementation to implementation depending upon numerous factors, such as price constraints, performance requirements, technological improvements, or other circumstances.

Embodiments of the present invention may be provided as a computer program product which may include a machine-readable medium having stored thereon instructions which may be used to program a general purpose computer, mode distribution logic, memory controller or other electronic devices to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other types of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

It is to be appreciated that a lesser or more complex aerial image, pixel function set, merit function, comparison process and new mask determination may be used than those shown and described herein. Therefore, the configurations may vary from implementation to implementation depending upon numerous factors, such as price constraints, performance requirements, technological improvements, or other circumstances. Embodiments of the invention may also be applied to other types of photolithography systems that use different materials and devices than those shown and described herein.

In the description above, numerous specific details are set forth. However, it is understood that embodiments of the invention may be practiced without these specific details. For example, well-known equivalent materials may be substituted in place of those described herein, and similarly, well-known equivalent techniques may be substituted in place of the particular processing techniques disclosed. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

1. A method comprising:
synthesizing a pixelated photolithography mask;
applying a pixel flipping function to the mask;
comparing the resulting mask to a desired result; and
synthesizing an optimized pixelated binary photolithography mask using the function.

2. The method of claim 1, wherein comparing comprises comparing a resulting aerial image to a target image for the mask.

3. The method of claim 1, wherein applying comprises applying a plurality of different pixel block flipping functions to the mask and wherein comparing comprises comparing a resulting aerial image for each different function to the target image, the method further comprising selecting a function based on the comparison.

4. The method of claim 1, wherein applying comprises applying the function to a portion of the mask and wherein comparing comprises comparing a resulting aerial image for the portion of the mask to a target image for the portion of the mask, and wherein synthesizing comprises synthesizing a whole mask using the function.

5. The method of claim 1, further comprising applying phase coloring to the mask before applying the function.

6. The method of claim 1, wherein the target image is generated by convolving a drawn layout corresponding to the mask with a function of the fabrication process to which the mask is to be applied.

7. The method of claim 1, wherein the pixel flipping function comprises at least one of sequential traversal, random traversal, objective weighted blocks, objective weighted traversal, and iterating.

8. A machine-readable medium containing instructions, which when operated on by the machine, cause the machine to perform operations comprising:
synthesizing a pixelated binary photolithography mask;
applying a plurality of different systematic pixel flipping functions to a portion of the mask;
comparing a resulting aerial image for the portion of mask after application of each function to a target image for the corresponding portion of the mask;
selecting a function based on the comparison; and
synthesizing an optimized pixelated binary photolithography mask using the selected function.

9. The medium of claim 8, the instructions further comprising applying phase coloring to the mask before applying the function.

10. The method of claim 8, wherein the target image is generated by convolving a drawn layout corresponding to the mask with a function of the fabrication process to which the mask is to be applied.

11. The method of claim 8, wherein the pixel flipping function comprises at least one of sequential traversal, random traversal, objective weighted blocks, objective weighted traversal, and iterating.

12. An apparatus comprising:
a memory;
a bus coupled to the memory; and
a microprocessor coupled to the bus, the microprocessor having a layer formed by photolithography using a mask, the mask being synthesized by:
synthesizing a pixelated photolithography mask;
applying a pixel flipping function to the mask;
comparing the resulting mask to a desired result;
synthesizing an optimized pixelated binary photolithography mask using the function.

13. The apparatus of claim 12, wherein comparing comprises comparing a resulting aerial image to a target image for the mask.

14. The apparatus of claim 12, wherein applying comprises applying a plurality of different pixel block flipping functions to the mask and wherein comparing comprises comparing a resulting aerial image for each different function to the target image, the method further comprising selecting a function based on the comparison.

15. The apparatus of claim 12, wherein applying comprises applying the function to a portion of the mask and wherein comparing comprises comparing a resulting aerial image for the portion of the mask to a target image for the portion of the mask, and wherein synthesizing comprises synthesizing a whole mask using the function.

16. The apparatus of claim 12, further comprising applying phase coloring to the mask before applying the function.

17. The apparatus of claim 12, wherein the target image is generated by convolving a drawn layout corresponding to the mask with a function of the fabrication process to which the mask is to be applied.

18. The apparatus of claim 12, wherein the pixel flipping function comprises at least one of sequential traversal, random traversal, objective weighted blocks, objective weighted traversal, and iterating.
